(19) United States
(12) Patent Application Publication
(10) Pub. No.: US 2006/0179471 A1
(43) Pub. Date: Aug. 10, 2006

(54) System and method for providing secure disclosure of a secret

(75) Inventor: Volker Roth, Omaha, NE (US)

Correspondence Address: DILLON & YUDELL LLP, 8911 NORTH CAPITAL OF TEXAS HWY, SUITE 2110, AUSTIN, TX, 78759, US

(73) Assignee: OGM Laboratory LLC

(21) Appl. No.: 11/054,375

(22) Filed: Feb. 9, 2005

(51) Int. Cl. H04L 9/32

(52) U.S. Cl. 726/2

(57) ABSTRACT

A method, system, and computer program product for processing entry of a secret that comprises an ordered sequence of elements. In accordance with the method of the present invention a set of elements is presented in a mutually fixed element arrangement to a prover. The presenting step further includes assigning in association with at least one of the presented elements, an attribute selected from a set of attributes, in which the number of selectable attributes is less than the number of elements presented in the fixed arrangement. A prover input corresponding to one or more of the presented attributes is received and processed to determine entry of an element of the secret.

### BACKGROUND OF THE INVENTION

1. Technical Field

The present invention relates generally to the field of data entry security and in particular to a method and system for securely entering a password or other code sequence. More particularly, the present invention relates to a method and system, applicable to user entry of secret codes such as passwords into data entry systems, for concealing the codes from eavesdropping.

2. Description of the Related Art

Maintaining password secrecy is essential to personal and system security in many data processing system transactions. Examples of transactions requiring password security include automated teller machines (ATMs) transactions, unlocking a portable computing and/or telephonic device, access authorization for high security areas, etc. Conventional password concealment techniques are often directed to obscuring the on-screen output presentation of a password string as it is entered, by, for example, displaying random numbers of generic symbols to represent each key input to thereby conceal the identity of each key and the string length.

A problem with prior art data entry encryption techniques relates to situations in which the human or electronic eavesdropper may observe the data input actuator apparatus (e.g. input keypad) or other data entry medium as the secret is entered. For short secrets in particular, an eavesdropper who observes and remembers the user-actuated input sequence renders the foregoing data entry concealment method ineffective.

Prior art attempts to address the problem of so-called “shoulder surfing” include methods for indirectly entering a secret code or password to protect the password from revelation by direct observation. U.S. Pat. No. 5,428,349, issued to Baker, present one such indirect password entry system employing a randomly generated array of alphanumeric keys. A user enters the password by selecting rows or columns containing the respective alphanumeric characters contained in the password string. The array is re-randomized after each indirect character entry and the next selection is made until the entire password is indirectly entered as a sequence of specified rows or columns corresponding to password characters contained therein. While at least partially addressing the problem of human or recorded observation of password entry, the Baker system places a substantial burden on the user entering the password (“prover”) in terms of user entry accuracy and speed. Changing the mutual orientation of the input elements is likely to confuse the prover and substantially delay correct entry of the secret.

U.S. Pat. No. 6,658,574, issued to Anvekar discloses an alternate indirect password entry technique wherein, in contrast to the system disclosed by Baker, the symbols directly corresponding to the password elements are maintained in a mutually fixed position such as on a display screen. Anvekar's system utilizes a symbol randomized coding technique wherein each password symbol is associated with a randomly selected “code” of digits. The randomized code assignment provides a one-to-one symbol translation function (i.e. single element corresponding to each randomly assigned code) and is input by the user using a counting “hit” key and a symbol demarcation “next” button. In contrast to Baker's method of randomly re-positioning the password elements and selecting indicia corresponding to the randomly selected password element positions corresponding to multiple possible characters, the translation codes used by Anvekar are uniquely assigned to each password character element thus necessitating a concealment hood for preventing an observer from mentally correlating the entered code with the password element with which it is associated. Furthermore, the complexity of tracking attribute identities that randomly change over each entry round and the per symbol entry technique requiring a series of “hit” and “next” key entries further tax the user's memory and concentration and may delay reliable password entry.

From the foregoing, it can be appreciated that a need exists for a system and method for receiving and verifying entry of a secret code string that overcomes the foregoing problems. The present invention addresses these and other needs unresolved by the prior art.

### SUMMARY OF THE INVENTION

A method, system, and computer program product for processing entry of a secret that comprises an ordered sequence of elements are disclosed herein. In accordance with the method of the present invention a set of elements is presented in a mutually fixed element arrangement to a prover. The presenting step further includes assigning in association with at least one of the presented elements, an attribute selected from a set of attributes, in which the number of selectable attributes is less than the number of elements presented in the fixed arrangement. A prover input corresponding to one or more of the presented attributes is received and processed to determine entry of an element of the secret.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram illustrating a password entry concealment system in accordance with one embodiment of the present invention;

FIG. 2A is a high-level flow diagram depicting steps performed during secret entry processing in accordance with one embodiment of the present invention;

FIG. 2B is a high-level flow diagram illustrating steps performed during secret entry processing in accordance with an alternate embodiment of the present invention;

FIG. 3A is a high-level flow diagram depicting steps performed for determining entry of a discrete element of a password in accordance with one embodiment of the present invention;

FIG. 3B is a high-level flow diagram illustrating steps performed for determining entry of a discrete element of a password in accordance with an alternate embodiment of the present invention;

FIG. 3C is a high-level flow diagram depicting steps performed for determining entry of a discrete element of a password in accordance with an alternate embodiment of the present invention;

FIG. 4 illustrates representative stepwise views of a visual based element presentation as controlled by a presenter and verifier over four prover entry cycles in accordance with one embodiment of the present invention; and

FIG. 5 depicts representative stepwise views of a tactile based element presentation as controlled by a presenter and verifier over three prover entry cycles in accordance with an alternate embodiment of the present invention.

### DETAILED DESCRIPTION OF ILLUSTRATIVE EMBODIMENT(S)

The present invention is generally directed to a method, system and computer program product for processing entry of a secret comprising an ordered sequence of elements. More specifically, the present invention provides a technique and means for enabling a user (referred to herein as a “prover”) to enter sequential strings of elements in a sufficiently indirect manner that the identity of individual elements constituting the secret remains substantially concealed from a human or limited-scope electronic eavesdropper.

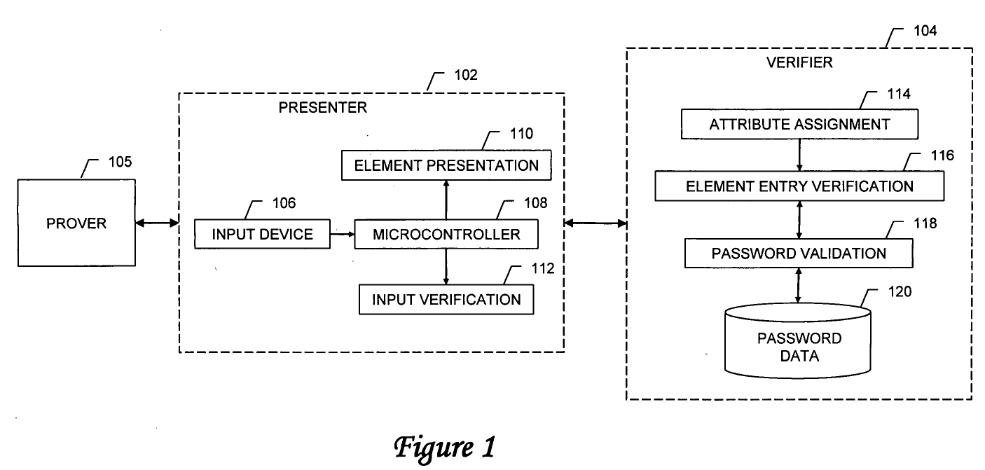

With reference now to the figures, wherein like reference numerals refer to like and corresponding parts throughout, and in particular with reference to FIG. 1, there is depicted a high-level block diagram illustrating a data processing system having processing and/or program means for enabling password entry concealment in accordance with one embodiment of the present invention. As shown in the depicted embodiment, the data processing system generally comprises a password entry presenter 102 communicatively coupled to a password verifier 104.

For discussion purposes, presenter 102 is depicted as a microcontroller-based system such as may be implemented in any of a number of personal identification number entry and verification systems such as automated teller machines (ATMs), personal data assistants (PDAs), mobile telephones, point-of-sale (POS) transaction processors, etc. Furthermore, it should be noted that the present invention is not limited to the foregoing types of systems in which the password or secret is user-centric, but also applies to processing entry of secrets that may be system-centric such as a gate entry verification system wherein the secret code may not be directly associated with a given user.

However, as used herein, the terms “password entry system,” “data processing system,” “computer,” and the like, are intended to mean essentially any type of computing device or machine that is capable of executing functions using hardware or software programming products. While the invention will be described in the general context of programs running in hardware or firmware modules, such as on an Application Specific Integrated Circuit (ASIC), System on Chip (SOC), or other programmable hardware and circuitry, those skilled in the art will recognize that the invention may also be implemented in combination with software program modules such as application programs executed in conjunction with an operating system on a personal computer. Generally, program modules include routines, programs, components, data structures, etc. that perform particular tasks or implement particular abstract data types. Moreover, those skilled in the art will appreciate that the invention may be practiced with other computer system configurations, including multiprocessor systems, microprocessor-based or programmable consumer electronics, minicomputers, mainframe computers, and the like.

A human or automated prover 105 may enter commands and information that are received by presenter 102 through an input device 106, which may be a PIN pad, keyboard, visual or tactile encoded touch pad, pointing device, etc. Other input devices (not shown) may include a microphone, joystick, game pad, antenna, scanner, or the like. These and other input devices may be connected to a processing unit, such as microcontroller 108 through some form of bus port or other interface (not depicted) that may be coupled to a controller bus (not depicted). The system further includes an element presentation device 110, which may be a visual display device such as a monitor or screen, an acoustic output device such as an audio speaker, a tactile output device such as a Braille pad, etc., that provides a perceptible output signal or display readily perceived by prover 105 during the method described below. While depicted as separate blocks, those skilled in the art will appreciate that the presentation device 110 may be functionally combined as an integrated unit with input device 106. Other types of supporting features (video adapters, etc.) may be included in support of the functions of input device 106 and element presentation device 110, and being well understood in the art, are not illustrated in the depicted embodiment for simplicity and clarity of illustration and description.

Presenter 102 further includes an input verification presentation device or module 112 that presents some form of perceptible indicia such a visual, audible, or tactile cue as feedback to the prover regarding the progress of password entry. An example of the prover awareness cue provided by input verification module 112 may generate a one of the many variations of progress indicators such as “progress bars” or a visually represented asterisks or other characters that would be understood by prover 105 to signify an extent or demarcation of password entry. While depicted as separate blocks for the purposes of description, input verification module 112 will typically be integrated into the output presentation functionality associated with element presentation device 110.

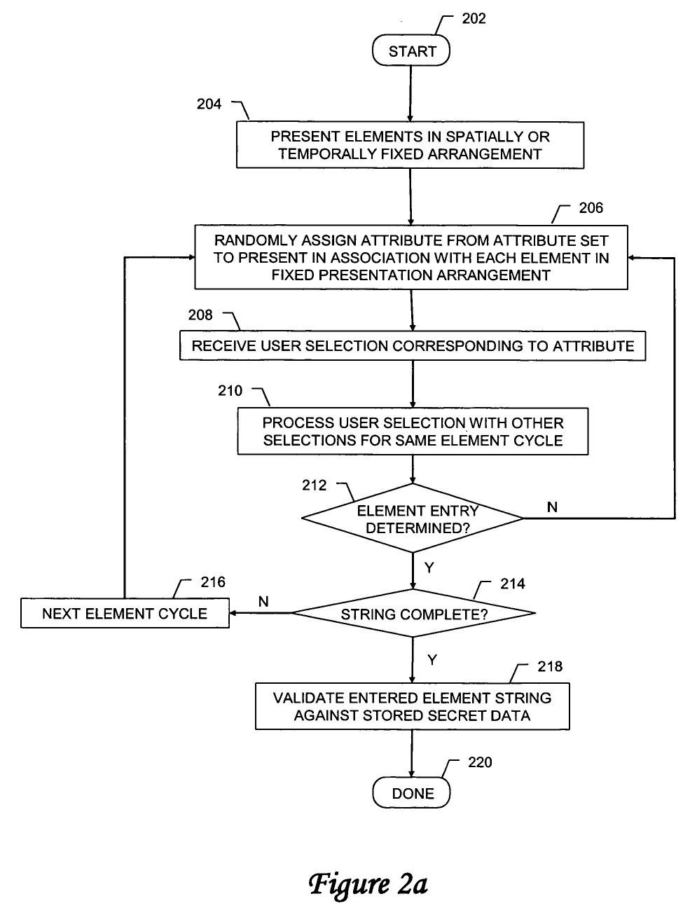

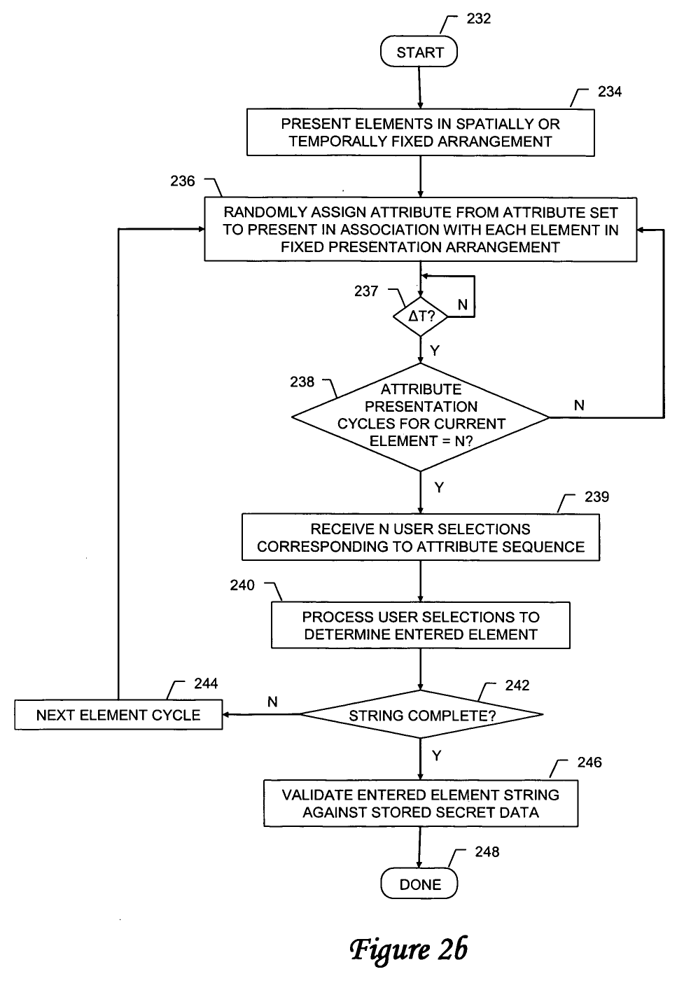

In accordance with the depicted embodiment, the system further includes hardware, firmware and/or software program modules and instructions (referred to hereinafter collectively as “programs” or “program resources”) within a system verifier 104. System verifier 104 includes several program resources including an attribute assignment module 114, an element entry verification module 116, and a password validation module 118. System verifier 104 also includes several supporting processing and data storage means that are not depicted for ease of illustration. As explained in further detail with reference to FIGS. 2-5, the program resources, including attribute assignment module 114, element entry verification module 116, password validation module 118, and other modules and programs supporting secure entry of secret element strings into the system may be deployed from one or more of a variety of data processing entities either depicted or not depicted in the exemplary embodiment.

As further illustrated in FIG. 1, a password data repository in the form of a database 120 or otherwise is also maintained by or in communicative contact with verifier 104. In one embodiment in which the secret is system-specific, or if the collection of valid secrets is otherwise maintained by verifier 104, password database 120 stores and updates data sequences corresponding to one or more secrets to be entered and verified. Such stored password data is accessible by validation instructions and modules within password validation module 118 for validating whether a prover-entered element sequence correctly corresponds directly or algorithmically to the secret validation criteria maintained by database 120.

In an alternate embodiment, the password validation criteria may input by the prover 105 during a given password entry sequence and only transiently maintained and processed by verifier 104. For example, the secret sought to be entered by prover 105 may be programmatically encoded (by circuit means, magnetically, optically, etc.) onto a so-called “smart card” the is input by inserting it into a smart card reader (not depicted), or a magnetic stripe card that is “input” by prover 105 such as by sliding the card through a magnetic stripe reader (not depicted) on presenter 102. Presenter 102 then reads and delivers the secret to a temporary storage equivalent to database 120 where password validation module 118 directly or algorithmically compares the card-encoded secret with the element sequence subsequently entered by prover 105 as part of the secret entry and validation process.

While depicted as separate blocks for ease and organization of discussion, the processing and program functionality of verifier 104 may be combined with those of presenter 102 within a given software or hardware device. Those skilled in the art will understand and appreciate that the entities depicted in FIG. 1 may be communicatively coupled using one or more of a variety of available physical and logical connection media and protocols. Such connectivity may be established, for example, using Bluetooth, WiFi, or IrDA technologies.

Moreover, the system components represented in FIG. 1 as presenter 102 and verifier 104 may be deployed in whole or in part from a mobile data processing device such as a PDA or cell phone. When deployed in this manner, presenter 102 may serve as a trusted entry terminal that receives instructions from the user (prover 105) that, in conjunction with attribute assignment module 114 and/or other, non-depicted element presentation modules within verifier 104, generates a specified display or display sequence on element presentation 110. A secure connection between the verifier-controlled presenter process and the prover-controlled presenter process on the prover's trusted hardware platform could be established and maintained in an ad hoc fashion. For example, a temporary connection between the prover's device displaying element presentation 110 and a networked entity storing various data and algorithms used by verifier 104 to reliably and secure download or otherwise exchange secret keys, handshakes, etc.

Furthermore, and while not illustrated in FIG. 1, the depicted data processing system including presenter 102 and verifier 104 may operate in or be distributed across a networked environment using logical connections to one or more remote processing devices (not depicted). Such remote devices may include servers, routers, peer devices or other common network nodes, and may include various data processing configuration similar or different than that shown in FIG. 1. In a networking embodiment, the physical and/or logical entities depicted in FIG. 1 may be communicatively interconnected over a local area network (LAN) and/or a wide area network (WAN) such as the Internet. Means for establishing communications over such networked configuration may include using various network interfacing devices such as network interfaces, modems, etc. In a networked environment, processing and program modules depicted relative to the data processing system, or portions thereof, may be stored in one or more remote (i.e., network distributed) memory devices.

The present invention is directed to provided a means by which a prover, such as prover 105 of FIG. 1 can securely enter sensitive data in the form of a sequence or string (typically an ordered sequence) of characters or “elements” that may be single or combined alphanumeric characters, wherein the general goal is to obscure from an eavesdropper the identity of the password elements as they are entered. For ease of discussion, the term “element” denotes the perceptible element indicia (e.g. letters ‘a’, ‘b’, ‘c’, etc.) that constitute the secret known to the prover. As utilized herein, “secret” refers to any group, sequence, or ordered sequence of one or more discrete elemental symbols (i.e. elements) such as numbers, letters, words, etc. Elements may be represented, such as on element presentation 110, in presentation forums such as keyboard keys, height or temperature adjustable pins or pads, audible icons, graphical icons, human or synthetic audible utterance of alphanumeric characters, etc.

With reference to FIG. 2A, there is illustrated a high-level flow diagram depicting steps performed such as by the system shown in FIG. 1 during secret entry processing in accordance with one embodiment of the present invention. The process commences as shown at steps 202 and 204 with multiple elements, such as alphanumeric characters on a PIN pad, being perceptibly presented in a spatially or temporally fixed mutual arrangement by or within presentation device 110. Such fixed presentations are commonly utilized such as on fixed keyboards and fixed electronic displays of multiple element characters. The substantially static arranging of the element characters is in contrast to systems that continuously or periodically vary the relative dispositions of elements on a presentation forum such as a visual display. In one embodiment, the fixed presentation depicted at step 204 is performed acoustically in which, for example, the elements are airborne or otherwise transmitted sounds or vibrations, and are thus presented by presentation module 110 in a sequential manner. In this example, the mutually fixed element arrangement shown at step 204 may constitute a consistently ordered sequence over which the constituent elements are presented over a time interval in a fixed order. In other embodiments, such as for a visual presentation, the set of elements are presented in a parallel manner by or within presentation device 110. It should be noted that as utilized herein, a “fixed” arrangement of elements denotes the mutually arrangement, in position or time, of the elements over the multiple “entry cycles” as described in further detail below.

Presentation of the elements further includes assignment of a perceptible attribute that is presented in association with each of the presented elements in the fixed arrangement as illustrated at step 206. In a preferred embodiment, the attribute assignment is performed by attribute assignment module 114 using a randomization algorithm (understood to encompass pseudo randomization in most practical applications) for each element in the fixed arrangement within element presentation 110, to randomly assign an attribute to be presented therewith from a set of selectable attributes. As utilized herein, an “attribute,” like an element, is characterized as having a perceptible identifier that may be visual, acoustic, tactile, etc. However, unlike the elements, the identifiable indicia of the attributes are not inherently related to the underlying secret sought to be entered by prover 105. Examples of preferred attributes include but are not limited to color, contrast, decorations of visible elements, elevation or extrusion of mechanically expressed elements, size or temperature of mechanically expressed elements, volume of audibly presented elements, presence or absence of elements, etc.

In an important feature of the present invention, the attribute randomly assigned to and presented in association with a given element is selected from a set of attributes, wherein the number of selectable attributes from which attribute assignment module 114 may select is less than the number of elements presented in element presentation 110. More specifically, and in a preferred embodiment for practicing the present invention, the number of selectable attributes is exactly two.

The randomly assigned attributes are presented in some perceptible association (explicit or implicit co-location, corresponding positions in an ordered sequence, etc.) with the elements presented by presentation device 110. In one embodiment, in which the set of elements is presented in parallel, such as in the visual display case, the corresponding assigned attributes are also displayed in parallel. In an alternate embodiment, the attributes may be presented sequentially when the elements are displayed in parallel, such as by sequentially illuminating one or more keys of a fixed keypad.

The method proceeds, as illustrated at step 208, with presenter 102 receiving a user selection (i.e. input from prover 105) corresponding to one of the attributes presented in association with the elements displayed by presentation device 110. The foregoing steps 204, 206, and 208 constitute what is referred to herein as an “entry cycle.” In a preferred embodiment, attribute assignment module 114 operates such that the set of perceptible identities of the entire pre-specified set of selectable attributes remains fixed over the multiple entry cycles processed during entry of a given secret. Furthermore, and as mentioned above, the preferred number of selectable attributes for each and all of the entry cycles is exactly two. The choice of exactly two selectable attributes, wherein the same number of elements is associated with each attribute, maximizes the uncertainty, or entropy, per entry cycle regarding the identity of the particular element that is the subject of that particular entry or element cycle. Any other number of selectable attributes results in a reduced uncertainty of the object element's identity. A mathematical proof supporting the use of exactly two selectable attributes per entry cycle is provided by Claude E. Shannon in “A Mathematical Theory of Communication,” Bell System Technical Journal, 27: pages 379-423 and 623-656, 1949, the content of which is incorporated herein by reference.

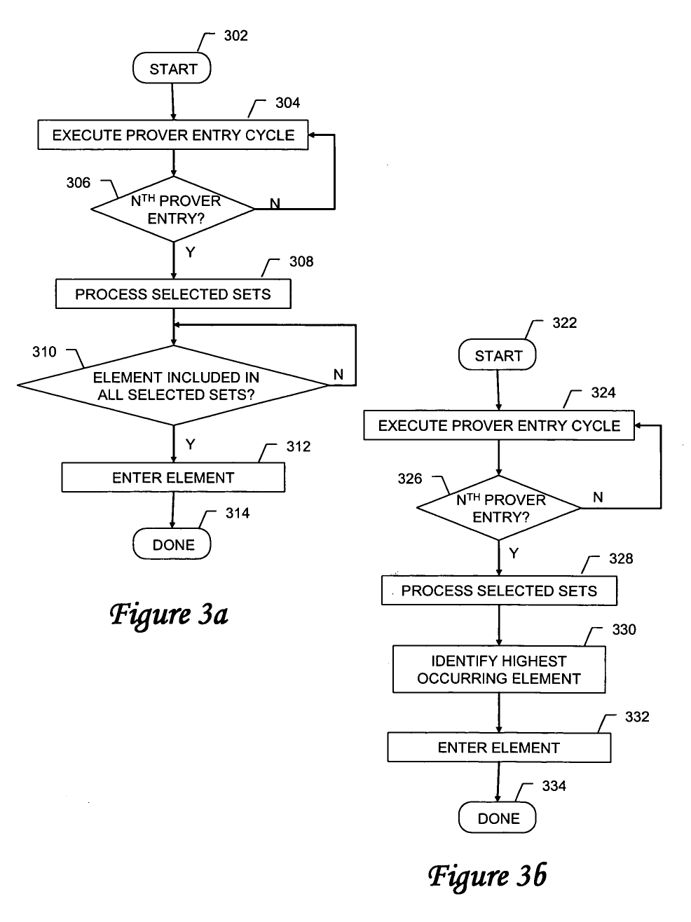

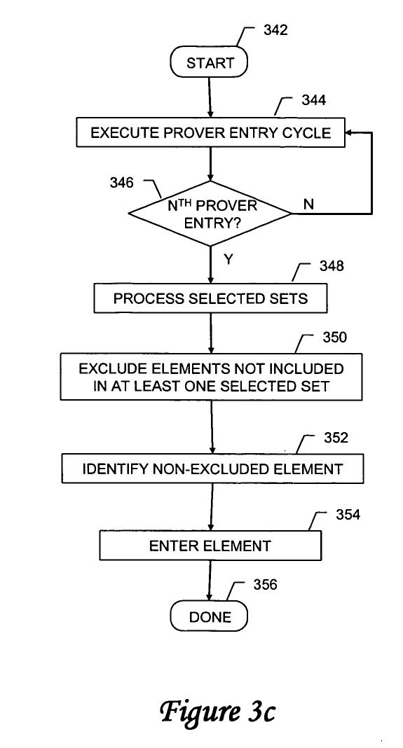

In accordance with the depicted embodiment, multiple entry cycles must be executed and processed to confirm entry or determine the identity of an element entered by prover 105 to the system. To this end, and as illustrated at step 210, element entry verification module 116 includes program modules, instructions and/or processing means for determining whether and which element from among the presented elements has been entered after a pre-specified or dynamically determined number of a entry cycles. If, as depicted at steps 212 and 206, the entered element has not been identified, a next entry cycle is commenced for the same element. More detailed embodiments for performing the element identification at steps 210 and 212 are depicted and explained in greater detail below with reference to FIGS. 3A-3C. As part of step 212, and as previously mentioned with reference to FIG. 1, the invention preferably provides some form of awareness prompt to the prover 105 to notify the prover that the same or a next element is to be indirectly entered beginning at the next entry cycle.

If, as shown at steps 212 and 214, a sufficient number of entry cycles have been completed to enable element entry verification module 116 to identify the entered element, password validation module 118 uses stored password data and related password function data to determine whether the entered element string is complete and valid. If so, the entry is validated and the process ends (steps 218 and 220). If, after entry of the last element, the string has not been completed, a next element cycle is commenced (step 216) possibly with some message to password validation module 118, and the process returns to the first entry cycle for the next element (step 206).

Referring now to FIG. 2B, there is depicted a high-level flow diagram illustrating steps performed during secret entry processing in accordance with an alternate embodiment of the present invention. The process commences as shown at steps 232 and 234 with the presentation of multiple elements in a spatially or temporally fixed mutual arrangement. As with the previous embodiment depicted in FIG. 2A, many different types and combinations of element presentations are possible with the limitation that a “fixed arrangement” of the elements must be established and maintained throughout the password entry processing. With continued similarity to the process explained with reference to FIG. 2A, the fixed mutual arrangement of elements are further presented in some implicit or explicit perceptible association with individually, randomly assigned attributes (step 236).

As shown at steps 237, 238 and 236, however, the process departs from the previous embodiment in that verifier 104 in conjunction with presenter 102 repeats the randomization and display set for a specified period, ΔT, over a each of a specified number of intervals, N. Thus, prover 105 perceives the sequence of N re-randomized attribute presentation cycles over a substantially continuous presentation sequence and is subsequently implicitly or expressly prompted to input a sequence of attribute selections sequentially corresponding to the presentation sequence.

The method proceeds, as illustrated at step 239, with presenter 102 receiving a prover input sequence comprising N consecutive prover input selections corresponding to the sequence of N presented attribute cycles. Assuming that the number of attribute presentation cycles, N, is sufficient to unambiguously identify an element as having been entered, only a single such prover input sequence is required to enter each element of the secret. Following the prover's entry of the input sequence corresponding to the attribute presentation sequence, and as illustrated at step 240, element entry verification module 116 includes program modules, instructions and/or processing means for processing the prover input sequence received at input device 106 to determine or identify the element “entered” from among the presented elements. FIGS. 3A-3C depict and describe more detailed embodiments performing the element identification shown at step 240. Continuing with the embodiment depicted in FIG. 2B, element presentation device 110 in conjunction with input verification module 112 informs prover 105 that an element has been entered and the process continues by proceeding to a next element cycle if the string is incomplete (steps 242, 244), or the string is validated by password validation module 118 and the process ends (steps 246, 248).

FIGS. 3A, 3B, and 3C illustrate three alternate processes employed by the present invention, such as may be executed in whole or in part by element entry verification module 116 in conjunction with attribute assignment module 114, to perform the determination or identification function for each element as it is entered into the system as generally represented at steps 210 and 212 of FIG. 2A and step 240 of FIG. 2B. First, FIG. 3A is a high-level flow diagram depicting steps performed for determining entry of a discrete element of a password or other secret string in accordance with one embodiment of the present invention. The element entry process begins as illustrated at step 302 and proceeds to step 304 with a prover entry cycle, referred to herein alternatively as an “entry cycle,” commenced and executed. One such entry cycle is generally depicted and explained with reference to steps 204, 206, and 208 of FIG. 2A, in which the elements are presented in a fixed arrangement and are further presented in association with attributes randomly selected from a set of attributes less than the number of presented elements, preferably two. The entry cycle of this embodiment concludes with receipt of a prover input corresponding to one of the presented attributes for the round demarcated by the attribute randomization shown at step 206. In the alternate embodiment shown in FIG. 2B, the entry cycle is depicted and described with reference to steps 236, 237, 238, and 239, wherein attribute assignment module 114, possibly in association with other depicted or non-depicted processing and program modules presents a sequence of N attribute “presentation cycles” in which a given randomized attribute assignment for the element set is displayed or otherwise presented over a specified period or sequence and the process repeated a sufficient number of rounds (i.e. N) such that the presently described set intersection techniques may identify the entered element with a sufficient level of reliability.

For the first embodiment depicted in FIG. 2A, following execution of a given entry cycle at step 304, a next entry cycle is executed until the pre-specified or dynamically specified number, N, of entry cycles has been reached (step 306). In a useful feature of the invention, and in accordance with the secret entry method depicted and described above with reference to FIGS. 2A and 2B, the subset of selected elements associated with the attribute corresponding to the prover input constitute a subset at least two elements referred to herein for clarity and consistency of reference as a “selected set.” Proceeding as illustrated at steps 308 and 310, the group of selected sets selected by the user input during the entry cycles is preferably processed using a set intersection or other correlation technique to determine the identity of the element entered by the prover during the current element cycle. For the embodiment shown in FIG. 3A, the entered element is identified as an element that is included in the selected sets for each of a specified number, M, wherein M≦N, of the N entry cycles (step 310). The element thus identified is entered and the element entry process concludes as shown at steps 312 and 314.

FIG. 3B is a high-level flow diagram illustrating steps performed for determining entry of a discrete element of a password or other secret in accordance with an alternate embodiment of the present invention. The element entry process begins as illustrated at step 322 and proceeds to step 324 with a prover entry cycle commenced and executed in a similar manner and with the same alternative entry cycle techniques as those explained with reference to FIG. 3A. Following execution of a given entry cycle at step 324, the next entry cycle is executed until the pre-specified or dynamically specified number, N, of entry cycles has been reached or the prover input sequence depicted at step 239 of FIG. 2B has been completed (step 326).

Proceeding as illustrated at steps 328 and 330, the selected sets corresponding to the entry cycles are preferably processed using an alternate set intersection or correlation technique to determine the identity of the element entered by the prover during the present element cycle. Specifically, and as shown at steps 330 and 332, the entered element is identified by entry verification module 116 as an element having the highest rate of occurrence in the N selected sets. The element thus identified is entered and the element entry process concludes as shown at step 334.

FIG. 3C is a high-level flow diagram illustrating steps performed for determining entry of a discrete element of a password or other secret in accordance with an alternate embodiment of the present invention. The element entry process begins as illustrated at step 342 and proceeds to step 344 with a prover entry cycle commenced and executed in a similar manner and with the same alternative entry cycle techniques as those explained with reference to the preceding figures. Following execution of a given prover entry cycle shown at step 344, the next entry cycle is commenced until the pre-specified or dynamically specified number, N, of entry cycles has been reached or the prover input sequence depicted at step 239 of FIG. 2B has been completed (step 346).

Proceeding as illustrated at steps 348 and 350, the selected sets corresponding to the entry cycles are preferably processed using an alternate set intersection or other correlation technique to determine the identity of the element entered by the prover during the current element cycle. Specifically, and as shown at steps 350 and 352, the entered element is identified by entry verification module 116 by excluding elements not included in at least one of the selected sets (for the current element entry cycle) and identifying as the entered element, one of the elements that was not excluded as per step 350. The element thus identified is entered and the element entry cycle concludes as shown at steps 354 and 356.

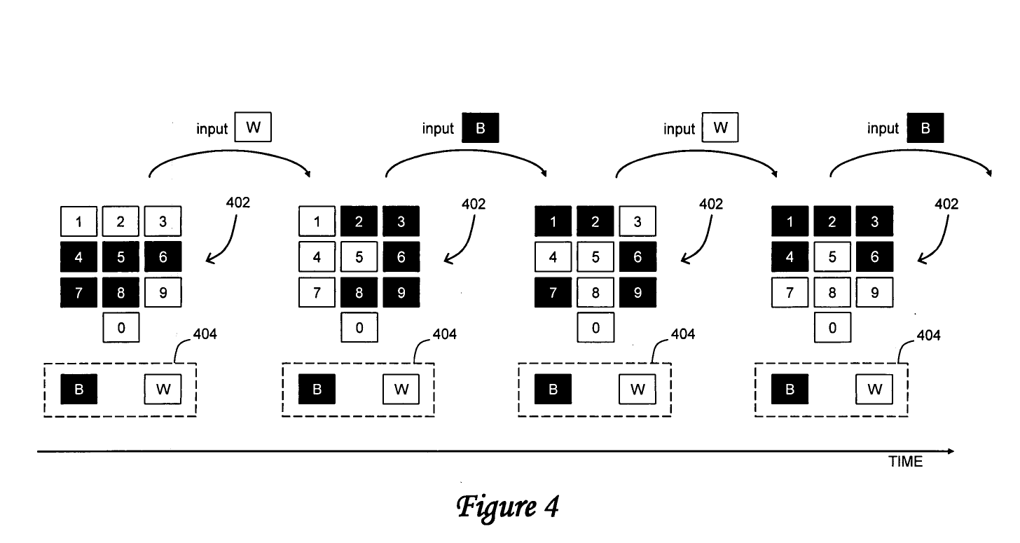

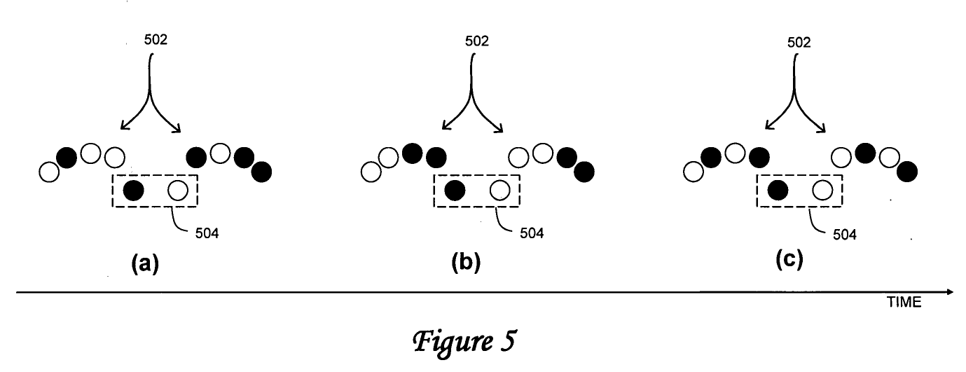

With reference now to FIGS. 4 and 5, there are depicted exemplary embodiments of the present invention as may be implemented by the system and method depicted in FIGS. 1-3. First, FIG. 4 illustrates representative stepwise views of a visual based element presentation as controlled by presenter 102 and verifier 104 over four prover entry cycles in accordance with one embodiment of the present invention. Specifically, a visual element presentation 402 is depicted as comprising the numeric characters 0-9 in a mutually fixed arrangement across four entry cycles. Presented in association with each digit element of arrangement 402 is a color attribute, in this case black or white background and a conversely colored digit representation.

The prover input mechanism comprises a prover select actuator 404 by which the prover may enter an attribute that has been assigned and presented in association with a particular element in the secret. Prover select actuator 404 may be incorporated as part of input device 106, and in the depicted embodiment comprises a pair of buttons or touch sensitive pads, one having a black colored background surrounding a letter “B” designating black, and the other having a white colored background surrounding a letter “W” designating white. The color and letter indicia on the two buttons within prover select actuator 404 correspond to the color identification (i.e. black and white) used as the attributes randomly assigned to the elements in each of the four entry cycles. It should be noted that, consistent with a preferred embodiment, the set of selectable attributes (i.e. black and white) includes exactly two attributes that remain unchanged in their perceptible identity over the multiple prover entry cycles. In this manner, a user more readily identifies and translates (as by selecting corresponding actuator buttons) the exact class of the two available selectable attributes and is less mentally taxed in having to perceive and interpret attributes that change in their perceptible identity over one or more entry cycles.

A single element cycle comprising a number of prover entry cycles required to enter a single element for a four-element secret assumed to be a four digit PIN sequence d₁d₂d₃d₄ is now described with reference to the depiction in FIG. 4. Generally, each digit element is entered/received as follows: (1) Attribute assignment module 114 in conjunction with presenter 102 randomizes the colors of the element keys by selecting either black or white from the set of selectable attributes. (2) A human or automated prover utilizes prover select actuator 404 to enter black if the color of the key representing one of the elements dᵢ is black, and enters white otherwise. (3) Steps (1) and (2) are repeated for a fixed or dynamically determined number of times (four in this example). (4) Element entry verification module 116 identifies dᵢ by intersecting the sets of digits which match the prover input selection for each of the four rounds.

FIG. 4 further depicts the stepwise process over which presenter 102 and verifier 104 control entry and processing of one element, dᵢ=3, included in a four-digit code. After the initial attribute randomization of the fixed element display, the display for digit “3” has the color attribute white. The prover enters white by pressing the button colored white and denoted “W” from prover select actuator 404. Verifier 104 then re-randomizes the color attributes, thereby replacing the previous color pattern with a new color pattern. The new color pattern assigned and presented in association with element “3” is now black in the second depicted entry cycle. Hence, presenter 102 receives a signal corresponding to prover selection of the prover select actuator “B” button. The process continues for two addition entry cycles in which the attribute and corresponding received prover selection alternates to white (third entry cycle) and black (fourth entry cycle).

Referring to FIG. 5, there are depicted representative stepwise views of a tactile-based element presentation as controlled by a presenter and verifier over three prover entry cycles in accordance with an alternate embodiment of the present invention. Being optimized for tactile sensing, the mechanisms by which the prover interfaces with presenter 102 consist of an element presentation 502 comprising multiple physical pins that can be raised or lowered under control of verifier 104 via a microcontroller or otherwise. The elements of this embodiment are the co-located pins and the attributes are raised or lowered. In the depicted embodiment, element presentation 502 comprises eight pin elements with the relative location/disposition of the pins serving as the element identification and which can be conveniently covered by eight fingers of an average human. A white-filled circle within element presentation 502 represents a raised pin while a solid- or black-filled circle within presentation 502 represents a pin that will be perceived by contact as being lowered. Two input buttons are included in a prover select actuator 504, which can be conveniently operated by the two remaining fingers such as the thumbs of a person. The button represented in actuator 504 as a non- or white-filled circle signifies a raised pin attribute while the button represented in actuator 504 as a solid- or black-filled circle corresponds to the lowered pin attribute.

A single element cycle (i.e. number of prover entry cycles required to enter a single element) for a five element secret represented as finger positions f₁ . . . f₅ of the eight possible fingers simultaneously positioned over each pin position in element presentation 502 is now described with reference to the depiction in FIG. 5. Generally, an element fᵢ is entered/received as follows: (1) The attribute assignment module 114 in conjunction with presenter 102 raises a random number of pins in element presentation 502. (2) A human or automated prover presses or otherwise selects the button within actuator 504 corresponding to raised if the pin under the finger fᵢ is raised, and presses the button corresponding to lowered otherwise. (3) Steps (1) and (2) are repeated for a fixed or dynamically determined number of times (three in this example). (4) Element entry verification module 116 identifies fᵢ by intersecting the sets of pins which match the prover input selection for each of the three entry cycles.

FIG. 5 further depicts the stepwise process over which presenter 102 and verifier 104 control entry and processing of one element, fᵢ, in which fᵢ is the left index finger position. As part of each entry cycle, the verifier 104 in concert with presenter 102 randomly raises or lowers the eight pins within element presentation 502 under the left and right index, middle, ring, and pinky fingers. The prover's thumbs preferably operate with two buttons in prover select actuator 504. As illustrated at entry cycle (a), the pin under the left index finger is lowered for the first entry cycle. Hence, the prover presses the black-filled circle button within actuator 504 corresponding to lowered. Verifier 104 again randomly raises or lowers the pins in element presentation for the second cycle (b) and as shown in the depicted presentation for cycle (b), the left index finger pin has been raised. The foregoing process continues for a prescribed number of iterations. In a practical setting comparable to contemporary PIN entry methods, a sequence of five fingers should be used as the secret, and log₂ 8=3 entry cycles per finger (element) are sufficient to unambiguously identify the finger.

In an alternate embodiment, the tactile based element presentation depicted in FIG. 5 may employ ten sensing pins within element presentation 502 with the palms or other parts of the prover's hands utilized to select the buttons in prover select actuator 504.

In the foregoing embodiments illustrated in FIGS. 4 and 5, the selected attributes (i.e. black/white, raised/lowered) are presented in parallel in association with each of the set of elements. In an alternate embodiment, the selected attributes may be presented in a sequential manner for a set of elements, such as those shown in FIGS. 4 and 5, that are presented in parallel to the prover.

In still an alternate embodiment, such as the aforementioned acoustic embodiment, the individual elements constituting the set of elements may be presented in a fixed, sequentially manner wherein the selected attributes are presented in parallel with each sequentially presented element. For example, the elements may be the numbers 0-9 presented as audible enunciations in a particular human language and the selectable attribute set may comprise presence or absence from a output audio string or may be two distinct pitch levels at which each element is audibly presented to the prover.

While the invention is described in the foregoing embodiments in the context of hardware/firmware type processing, the disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like.

Alternatively, the disclosed computer controlled code-completion system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The computer controlled secret entry systems and methods described above, however, can be readily implemented in hardware and/or software using any known or later-developed systems or structures, devices and/or software by those skilled in the applicable art without undue experimentation from the functional description provided herein together with a general knowledge of the computer arts.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A method for processing entry of a secret that comprises an ordered sequence of elements, said method comprising:
(a) presenting a set of elements in a fixed arrangement;
(b) presenting in association with at least one of the presented elements, an attribute selected from a set of attributes, wherein the number of selectable attributes is less than the number of elements presented in the fixed arrangement; and
(c) receiving and processing a prover input corresponding to a presented attribute.

2. The method of claim 1, wherein steps (a) and (b) further comprise presenting the set of elements in association with attributes on a visual display device, or an acoustic output device, or a tactile output device.

3. The method of claim 1, wherein the number of selectable attributes is two.

4. The method of claim 1, wherein step (b) further comprises randomly assigning to each presented element, an attribute to be presented in association therewith from the set of selectable attributes.

5. The method of claim 4, wherein step (b) is repeated following step (c).

6. The method of claim 4, further comprising executing a presentation sequence, wherein the presentation sequence comprises:
maintaining the attribute presentation of step (b) for a specified period; and
repeating step (b) and said maintaining step for a specified number of attribute presentation cycles prior to said step (c).

7. The method of claim 6, further comprising, following said specified number of attribute presentation cycles in the presentation sequence:
receiving a prover input sequence comprising multiple prover input attribute selections sequentially corresponding to the attribute presentation cycles; and
processing the prover input sequence to identify an element entered from among the presented elements.

8. The method of claim 1, wherein steps (a), (b), and (c) constitute an entry cycle, said method further comprising performing multiple entry cycles during processing entry of the secret.

9. The method of claim 8, wherein step (a) comprises maintaining the set of elements in a mutually fixed arrangement over said multiple entry cycles.

10. The method of claim 8, wherein the set of the selectable attributes has a corresponding set of perceptible identities that remain fixed over each of said multiple entry cycles.

11. The method of claim 8, further comprising performing multiple entry cycles to determine each entry of one or more of the presented elements.

12. The method of claim 11, wherein for each of the multiple entry cycles, the presented elements associated with the attribute corresponding to the prover input constitute a selected set, said determining entry of an element further comprising identifying as the entered element, an element included in the selected sets for each of a specified number of the multiple entry cycles.

13. The method of claim 11, wherein said determining entry of an element is performed using a set intersection technique.

14. The method of claim 11, wherein for each of the multiple entry cycles, the presented elements associated with the attribute corresponding to the prover input make up a selected set, said determining entry of an element further comprising identifying as an entered element, the element having the highest rate of occurrence in the selected sets.

15. The method of claim 11, wherein for each of the multiple entry cycles, the presented elements associated with the attribute corresponding to the prover input make up a selected set, said determining entry of an element further comprising:
excluding elements not included in at least one of the selected sets; and
identifying as an entered element, a non-excluded element from the selected sets.

16. The method of claim 11, further comprising:
repeating said determining each entry of one or more of the presented elements over n element cycles, wherein n is a number equal to the number of elements in the secret; and
verifying the entered elements against stored values corresponding to valid secrets.

17. A system for processing entry of a secret that comprises an ordered sequence of elements, said system comprising:
a presenter that presents a set of elements in a fixed arrangement; and
a verifier having an attribute assignment module that assigns for presentation in association with at least one of the presented elements, an attribute selected from a set of attributes, wherein the number of selectable attributes is less than the number of elements presented in the fixed arrangement, and wherein said verifier further includes an element entry verification module that receives and processes a prover input corresponding to a presented attribute.

18. The system of claim 17, wherein said presenter further comprises an element presentation device that presents the set of elements in association with attributes on a visual display device, or an acoustic output device, or a tactile output device.

19. The system of claim 17, wherein the number of selectable attributes is two.

20. The system of claim 17, wherein said attribute assignment module randomly assigns to each presented element, an attribute to be presented in association therewith from the set of selectable attributes.

21. The system of claim 20, wherein said attribute assignment module repeats the random assignment of attributes to each presented element following receipt and processing of the prover input corresponding to a presented attribute.

22. The system of claim 20, wherein said verifier further comprises means for executing a presentation sequence, wherein the presentation sequence comprises:
maintaining the attribute presentation for a specified period; and
repeating said attribute assignment and said maintaining the attribute presentation for a specified number of attribute presentation cycles prior to said receiving and processing a prover input corresponding to a presented attribute.

23. The system of claim 22, further comprising:
means for receiving a prover input sequence comprising multiple prover input attribute selections sequentially corresponding to the attribute presentation cycles; and
means for processing the prover input sequence to identify an element entered from among the presented elements.

24. The system of claim 17, wherein said presenter presents a set of elements in a fixed arrangement and said verifier assigns an attribute during an entry cycle, said system further comprising means for performing multiple entry cycles during processing entry of the secret.

25. The system of claim 24, further comprising means for determining each entry of one or more of the presented elements over multiple entry cycles.

26. The system of claim 25, wherein for each of the multiple entry cycles, the presented elements associated with the attribute corresponding to the prover input constitute a selected set, said means for determining entry of an element further comprising means for identifying as the entered element, an element included in the selected sets for each of a specified number of the multiple entry cycles.

27. The system of claim 25, wherein said means for determining entry of an element is performed using a set intersection technique.

28. The system of claim 25, wherein for each of the multiple entry cycles, the presented elements associated with the attribute corresponding to the prover input make up a selected set, said means for determining entry of an element further comprising means for identifying as an entered element, the element having the highest rate of occurrence in the selected sets.

29. The system of claim 25, wherein for each of the multiple entry cycles, the presented elements associated with the attribute corresponding to the prover input make up a selected set, said means for determining entry of an element further comprising means for:
excluding elements not included in at least one of the selected sets; and
identifying as an entered element, a non-excluded element from the selected sets.

30. The system of claim 25, further comprising means for:
repeating said determining each entry of one or more of the presented elements over n element cycles, wherein n is a number equal to the number of elements in the secret; and
verifying the entered elements against stored values corresponding to valid secrets.

31. A computer-readable medium having encoded thereon computer-executable instructions for processing entry of a secret that comprises an ordered sequence of elements from among a set of elements presented to a prover in a fixed arrangement, said computer-executable instructions performing a method comprising:
(a) assigning for presentation in association with at least one of the presented elements, an attribute selected from a set of attributes, wherein the number of selectable attributes is less than the number of elements presented in the fixed arrangement; and
(b) receiving and processing a prover input corresponding to a presented attribute.

32. The computer-readable medium of claim 31, wherein the number of selectable attributes is two.

33. The computer-readable medium of claim 31, wherein step (a) further comprises randomly assigning to each presented element, an attribute to be presented in association therewith from the set of selectable attributes.

34. The computer-readable medium of claim 31, wherein step (a) is repeated following step (b).

35. The computer-readable medium of claim 31, wherein said method further compress executing a presentation sequence, wherein the presentation sequence comprises:
maintaining an attribute presentation in accordance with the assignment of step (a) for a specified period; and
repeating step (a) and said maintaining step for a specified number of attribute presentation cycles prior to said step (b).

36. The computer-readable medium of claim 35, further comprising, following said specified number of attribute presentation cycles in the presentation sequence:
receiving a prover input sequence comprising multiple prover input attribute selections sequentially corresponding to the attribute presentation cycles; and
processing the prover input sequence to identify an element entered from among the presented elements.

37. The computer-readable medium of claim 31, wherein steps (a) and (b) constitute an entry cycle, said method further comprising performing multiple entry cycles during processing entry of the secret.

38. The computer-readable medium of claim 37, said method further comprising performing multiple entry cycles to determine each entry of one or more of the presented elements.

39. The computer-readable medium of claim 37, wherein for each of the multiple entry cycles, the presented elements associated with the attribute corresponding to the prover input constitute a selected set, said determining entry of an element further comprising identifying as the entered element, an element included in the selected sets for each of a specified number of the multiple entry cycles.

40. The computer-readable medium of claim 37, wherein said determining entry of an element is performed using a set intersection technique.

41. The computer-readable medium of claim 37, wherein for each of the multiple entry cycles, the presented elements associated with the attribute corresponding to the prover input make up a selected set, said determining entry of an element further comprising identifying as an entered element, the element having the highest rate of occurrence in the selected sets.

42. The computer-readable medium of claim 37, wherein for each of the multiple entry cycles, the presented elements associated with the attribute corresponding to the prover input make up a selected set, said determining entry of an element further comprising:
excluding elements not included in at least one of the selected sets; and
identifying as an entered element, a non-excluded element from the selected sets.

43. The computer-readable medium of claim 37, said method further comprising:
repeating said determining each entry of one or more of the presented elements over n element cycles, wherein n is a number equal to the number of elements in the secret; and
verifying the entered elements against stored values corresponding to valid secrets.

44. In a data entry processing system having a set of elements presented to a prover in a mutually fixed arrangement, a method for processing entry of a secret that comprises an ordered sequence of elements, said method comprising:
randomly assigning for presentation in association with at least one of the presented elements, an attribute selected from a set of attributes, wherein the number of selectable attributes within the set is less than the number of elements presented in the fixed arrangement; and
receiving and processing a prover input corresponding to a presented attribute.

45. The method of claim 44, wherein the number of selectable attributes is two.

46. In a data entry processing system having a set of elements presented to a prover in a mutually fixed arrangement, a system for processing entry of a secret that comprises an ordered sequence of elements, said system comprising:
processing means for randomly assigning for presentation in association with at least one of the presented elements, an attribute selected from a set of attributes, wherein the number of selectable attributes within the set is less than the number of elements presented in the fixed arrangement; and
processing means for receiving and processing a prover input corresponding to a presented attribute.

47. The system of claim 46, wherein the number of selectable attributes is two.

48. A computer-readable medium for use with a data entry processing system having a set of elements presented to a prover in a mutually fixed arrangement, said computer-readable medium having encoded thereon computer-executable instructions for processing entry of a secret that comprises an ordered sequence of elements, said computer-executable instructions performing a method comprising:
randomly assigning for presentation in association with at least one of the presented elements, an attribute selected from a set of attributes, wherein the number of selectable attributes within the set is less than the number of elements presented in the fixed arrangement; and
receiving and processing a prover input corresponding to a presented attribute.

49. The computer-readable medium of claim 48, wherein the number of selectable attributes is two.
